(19) United States
(12) Patent Application Publication
(10) Pub. No.: US 2005/0078126 A1
(43) Pub. Date: Apr. 14, 2005

(54) Method and apparatus for scaling image in horizontal and vertical directions

(75) Inventors: Yong-cheol Park, Yongin-si (KR); E-woo Chun, Seoul (KR)

Correspondence Address: Anthony P. Onello, Jr.;MILLS & ONELLO LLP, Eleven Beacon Street, Suite 605, Boston, MA, 02108, US

(73) Assignee: Samsung Electronics Co., Ltd.

(21) Appl. No.: 10/952,395

(22) Filed: Sep. 28, 2004

(30) Foreign Application Priority Data
Sep. 29, 2003 (KR) 03-67431

(51) Int. Cl. G09G 5/00

(52) U.S. Cl. 345/665; 348/581

(57) ABSTRACT

In an up-scaler and method for up-scaling an input image frame in vertical and horizontal directions and generating an up-scaled output image frame, the up-scaler includes a timing generator that generates an output clock signal and a sampling frequency converter that outputs a plurality of duplicated pixel data in response to the output clock signal. The timing generator generates the output clock signal such that a duration corresponding to a vertical active period of the up-scaled output image frame and a duration corresponding to a vertical active period of the input image frame are equal. The sampling frequency converter receives pixel data that forms the input image frame in response to an input clock signal, duplicates the pixel data in the vertical and horizontal directions as many times as a vertical scaling factor and a horizontal scaling factor, respectively, and outputs the duplicated pixel data in response to the output clock signal.

### CROSS REFERENCE TO RELATED APPLICATION

This application claims the priority of Korean Patent Application No. 2003-67431, filed on Sep. 29, 2003, in the Korean Intellectual Property Office, the disclosure of which is hereby incorporated by reference in its entirety.

### BACKGROUND OF THE INVENTION

1. Field of the Invention

The present invention relates to a method and apparatus for scaling an image, and more particularly, to a method and apparatus for scaling an image without using a frame buffer.

2. Description of the Related Art

Image scaling involves creating an output image of a predetermined size selected by a user without necessarily maintaining the aspect ratio of the input image. In general, a scaler that performs image scaling includes a frame buffer. The scaler stores data of a corresponding frame in the frame buffer, and reads out the data of the corresponding frame stored in the frame buffer when necessary. Inclusion of the frame buffer in the scaler complicates the resulting system and increases the cost of implementation of the system.

U.S. Pat. No. 5,739,867 discloses a method and apparatus for upscaling an image, in which a source image is received in response to a first clock signal and a destination image is generated in response to a second clock signal using a scaling ratio. The frequency ratio between the first clock signal and the second clock signal is determined by a corresponding aspect ratio with respect to one frame period. In other words, the frequency of the second clock signal is the result of dividing the first clock signal by a predetermined number, so that the frame rate of the source image frame and the frame rate of the destination image frame can be equal. Thus, if a vertical sync signal, a horizontal sync signal, and the first clock signal for the source image frame and a vertical sync signal and a horizontal sync signal for the destination image frame are provided, the frequency of the second clock signal is generated using the frequency ratio of input vertical sync signal to output vertical sync signal or input horizontal sync signal to output horizontal sync signal.

However, according to the method and apparatus disclosed in U.S. Pat. No. 5,739,867, the number of lines of the blank period of the destination image frame is proportional to the number of lines of the blank period of the source image frame and the duration of the output sync signal of the destination image frame is proportional to that of the input sync signal of the source image frame. As a result, the frequencies of the vertical/horizontal sync signals for outputting the destination image frame unnecessarily increase.

### SUMMARY OF THE INVENTION

The present invention provides a method and apparatus for up/down scaling an image by generating a clock signal such that the duration of a vertical active period of an input image frame and the duration of a vertical active period of an output image frame can be equal.

According to one aspect of the present invention, there is provided an up-scaler, which up-scales an input image frame in vertical and horizontal directions and generates an up-scaled output image frame. The up-scaler comprises a timing generator and a sampling frequency converter. The timing generator generates an output clock signal based on an independently generated clock signal, for example a crystal clock signal generated by a crystal oscillator, and the sampling frequency converter receives pixel data that forms the input image frame in response to an input clock signal, duplicates the received plurality of pixel data in the vertical and horizontal directions as many times as a vertical scaling factor and a horizontal scaling factor, respectively, and outputs the duplicated pixel data in response to the output clock signal. The timing generator generates the output clock signal, so that a duration corresponding to a vertical active period of the input image frame and a duration corresponding to a vertical active period of the output image frame up-scaled by the output clock signal are equal.

In one embodiment, the timing generator controls a period of the output clock signal, so that the duration corresponding to the vertical active period of the input image frame and the duration corresponding to the vertical active period of the up-scaled output image frame are equal.

In another embodiment, the timing generator comprises a pre-divider, a phase-locked loop (PLL), and a decimal fraction adder. The pre-divider divides the independently generated clock signal in response to a first division control signal. The PLL phase locks the output clock signal to an output signal of the pre-divider and outputs the output clock signal in response to a second division control signal. The decimal fraction adder controls the second division control signal in response to a third division control signal such that the second division control signal has an integer value.

In another embodiment, the timing generator further comprises a sync signal generator that receives the input clock signal, the output clock signal, and an input sync signal that corresponds to the input image frame and generates an output sync signal that corresponds to the output image frame.

In another embodiment, a start point of an active period of the output sync signal is generated at the same time as a start point of the vertical active period of the input image frame.

In another embodiment, the output sync signal includes an output vertical sync signal and an output horizontal sync signal and a vertical blank period of the output image frame includes at least one incomplete horizontal sync signal.

In another embodiment, the sampling frequency converter comprises a dual port SRAM or a dual bank SRAM. For example, the sampling frequency converter comprises a dual port SRAM and the pixel data that forms the input image frame is written to the dual port SRAM through one of two input ports of the SRAM in response to the input clock signal and the plurality of duplicated pixel data is read through one of the two output ports of the SRAM in response to the output clock signal.

In another embodiment, the up-scaler further comprises a line buffer that stores the plurality of duplicated pixel data output from the sampling frequency converter. The up-scaler further comprises an interpolator that interpolates the pixel data stored in the line buffer and generating the up-scaled output image frame.

According to another aspect of the present invention, there is provided an up-scaler, which up-scales an input image frame in vertical and horizontal directions and creates an up-scaled output image frame. The up-scaler comprises a timing generator and a sampling frequency converter. The timing generator generates an output clock signal based on an independently generated clock signal, for example, a crystal clock signal output from a crystal oscillator. The sampling frequency converter receives pixel data that forms the input image frame in response to an input clock signal, duplicates the pixel data in the vertical and horizontal directions as many times as a vertical scaling factor and a horizontal scaling factor, respectively, and outputs the plurality of duplicated pixel data in response to the output clock signal. The timing generator generates the output clock signal based on the following equation:
CKO=(VACTI*CKI*HITOTAL)/(VACTO*HOTOTAL),
where CKO represents the period of the output clock signal, VACTI represents the number of input scan lines that forms a vertical active period of the input image frame, CKI represents the period of the input clock signal, HITOTAL represents the number of pixels that forms one input scan line, VACTO represents the number of output scan lines that forms the up-scaled output image frame, and HOTOTAL represents the number of pixels that forms one output scan line.

According to still another aspect of the present invention, there is provided a method of up-scaling an input image frame in vertical and horizontal directions and generating an up-scaled output image frame, the method comprising generating an output clock signal based on an independently generated clock signal output, for example a crystal clock signal from a crystal oscillator, and receiving pixel data that forms the input image frame in response to an input clock signal, duplicating the pixel data in the vertical and horizontal directions as many times as a vertical scaling factor and a horizontal scaling factor, respectively, and outputting the duplicated pixel data in response to the output clock signal.

Each of a plurality of scan lines that forms the up-scaled output image frame includes a plurality of active pixels and a plurality of blank pixels, and the number of the plurality of blank pixels that forms each of the scan lines is not necessarily equal for the vertical scaling factor and the horizontal scaling factor.

According to yet another aspect of the present invention, there is provided a method of up-scaling an input image frame in vertical and horizontal directions and generating an up-scaled output image frame, the up-scaling method comprising receiving pixel data that forms the input image frame in response to an input clock signal, duplicating the pixel data in the vertical and horizontal directions as many times as a vertical scaling factor and a horizontal scaling factor, respectively, and outputting the plurality of duplicated pixel data in response to the output clock signal. A period of the output clock signal is controlled such that a duration corresponding to a vertical active period of the up-scaled output image frame and a duration corresponding to a vertical active period of the input image frame are equal.

In one embodiment, a duration corresponding to a blank period of the up-scaled output image frame is different from a duration corresponding to a blank period of the input image frame.

In another embodiment, the up-scaling method further comprises receiving the plurality of duplicated pixel data and interpolating the plurality of received pixel data, thereby generating the up-scaled output image frame.

According to yet another aspect of the present invention, there is provided a method of up-scaling an input image frame in vertical and horizontal directions and generating an up-scaled output image frame, the up-scaling method comprising receiving pixel data that forms the input image frame in response to an input clock signal, duplicating the pixel data in the vertical and horizontal directions as many times as a vertical scaling factor and a horizontal scaling factor, generating an output clock signal such that all duplicated pixel data can be output during a vertical active period of the input image frame by the input clock signal, and outputting the plurality of duplicated pixel data in response to the output clock signal.

### BRIEF DESCRIPTION OF THE DRAWINGS

The above and other aspects and advantages of the present invention will become more apparent by describing in detail an exemplary embodiment thereof with reference to the attached drawings in which:

FIG. 1 illustrates sync signals of a conventional video signal;

FIG. 2 illustrates the horizontal sync signal of FIG. 1;

FIG. 3 is a block diagram of an apparatus for up/down scaling an image according to an embodiment of the present invention;

FIG. 4 is a block diagram of an input format converter of FIG. 3;

FIG. 5 is a block diagram of a timing generator of FIG. 3;

FIG. 6 is a timing diagram that illustrates the basic operation of the timing generator of FIG. 3;

FIG. 7 is a block diagram of a clock generator of FIG. 3;

FIG. 8 is a timing diagram that illustrates the operation of a decimal adder of FIG. 7;

FIG. 9 is a timing diagram of input/output signals of the timing generator of FIG. 5 and

FIG. 10 is a timing diagram of a blank period of an output vertical sync signal generated by the timing generator of FIG. 5.

### DETAILED DESCRIPTION OF THE INVENTION

The present invention will now be described more fully with reference to the accompanying drawings, in which an exemplary embodiment of the invention is shown. Throughout the drawings, like reference numerals refer to like elements.

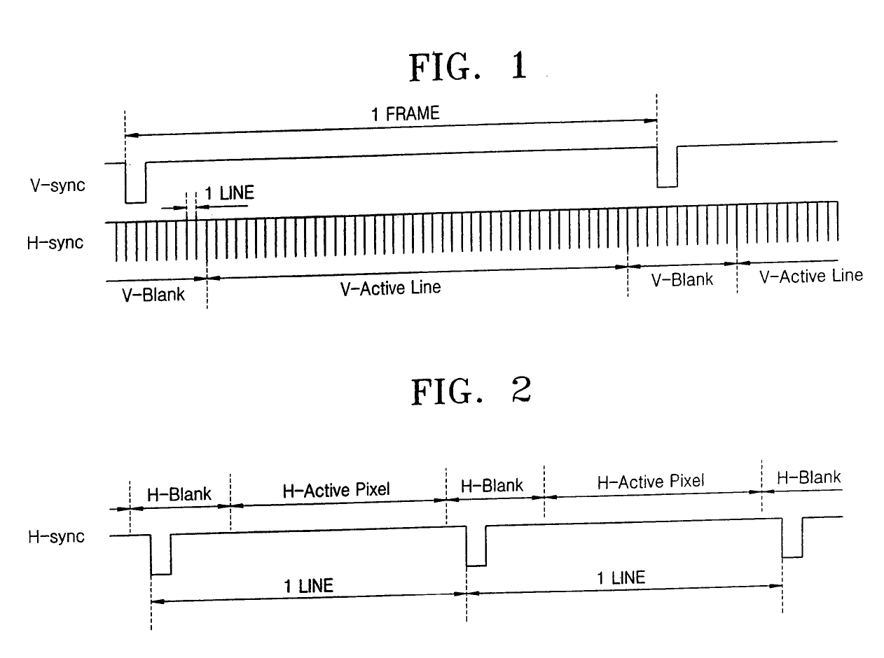

FIG. 1 illustrates vertical sync signals “V-sync” and horizontal sync signals “H-sync” of a conventional video signal. Referring to FIG. 1, a vertical sync signal V-sync indicates a frame of a video signal and a horizontal sync signal H-sync corresponds to a scan line.

As is well known in this field, one frame is composed of a plurality of scan lines. The frame is divided into a vertical active period V-Active Line and a vertical blank period V-Blank. The vertical active period V-Active Line is composed of a plurality of scan lines into which video data is loaded. The vertical blank period V-Blank is composed of a plurality of scan lines into which video data is not loaded and is used for screen synchronization.

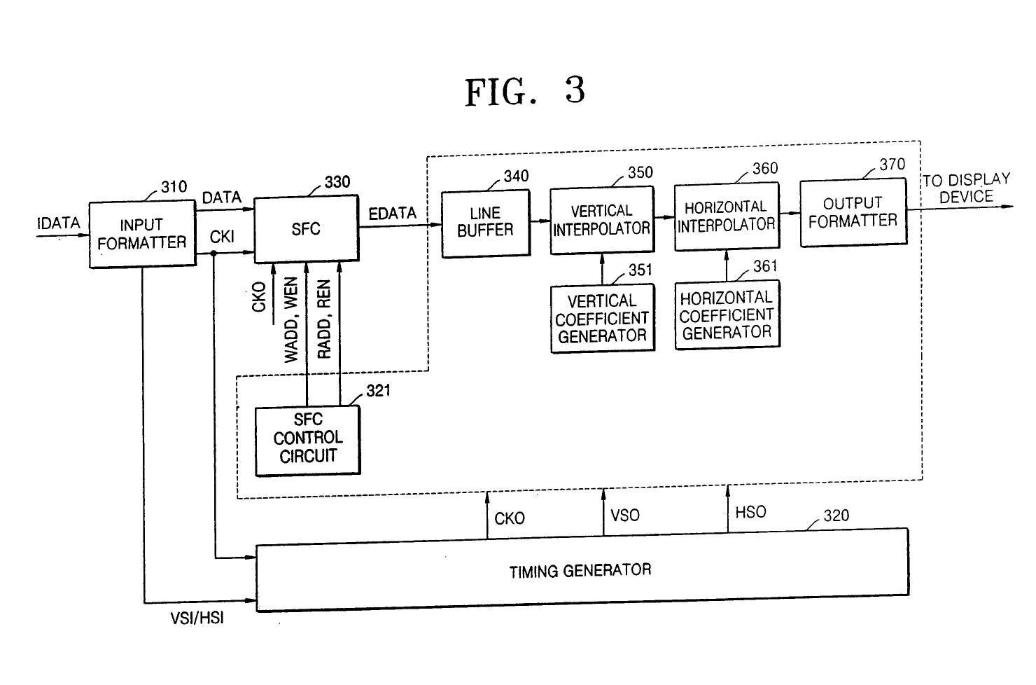

FIG. 2 illustrates a detailed view of the horizontal sync signal H-sync of FIG. 1. Referring to FIG. 2, one scan line is created during one period of the horizontal sync signal H-sync.

Each scan line is divided into a horizontal active pixel zone H-Active Pixel and a horizontal blank sync signal zone H-Blank. Each of the horizontal active pixel zones H-Active Pixel and each of the horizontal blank sync signal zones H-Blank is composed of a plurality of pixels, and real video data is loaded into the active pixel zone H-Active Pixel. In other words, in each image frame, real image data is loaded only into the horizontal active pixel zone H-Active Pixel of the vertical active period V-Active Line.

FIG. 3 is a block diagram of an apparatus for up/down scaling an image according to an exemplary embodiment of the present invention. Referring to FIG. 3, the apparatus for up/down scaling an image includes an input formatter 310, a timing generator 320, a sampling frequency converter (SFC) control circuit 321, an SFC 330, a line buffer 340, a vertical interpolator 350, a vertical coefficient generator 351, a horizontal interpolator 360, a horizontal coefficient generator 361, and an output formatter 370.

Here, the vertical interpolator 350, the vertical coefficient generator 351, the horizontal interpolator 360, and the output formatter 370 constitute an interpolator that performs interpolation according to scaling of an image signal. Also, signals CKO, VSO, and HSO output from the timing generator 320 are input to one of the SFC control circuits 321, 340, 350, 351, 360, 361, and 370.

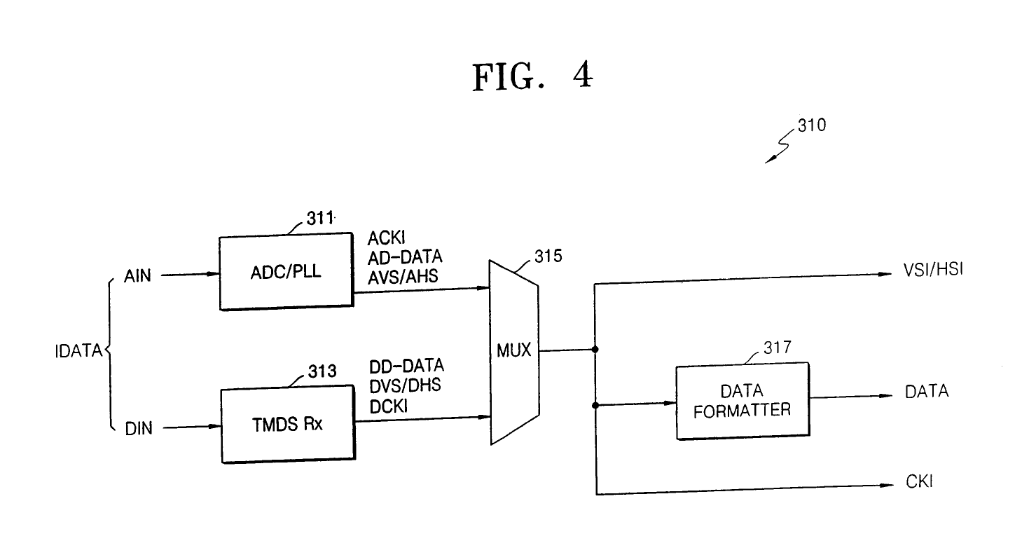

The input formatter 310 receives input data IDATA and transforms the input data IDATA into a format suitable for use in the SFC 330. An analog-to-digital converter (ADC)/phase locked loop (PLL) 311 shown in FIG. 4 operating in a dual mode doubles the time of the input signal IDATA and reduces the frequency of the input signal IDATA to ½, using a time division method. Thus, electromagnetic interference (EMI) is reduced and the operating speed of the system increases. However, the usefulness of such an operation of the ADC/PLL 311 decreases in a system-on-chip (SOC) design.

FIG. 4 is a block diagram of the input formatter 310 of FIG. 3. Referring to FIGS. 3 and 4, the input formatter 310 includes the ADC/PLL 311, a transition minimized differential signaling (TMDS) receiver 313, a selection circuit 315, and a data formatter 317.

The ADC/PLL 311 transforms an analog input signal AIN into digital data AD_DATA, receives an analog vertical sync signal and an analog horizontal sync signal, and generates a clock signal ACKI in response to the analog vertical sync signal and the analog horizontal sync signal. The ADC/PLL 311 outputs the digital data AD_DATA and the input clock signal ACKI to the selection circuit 315. The ADC/PLL 311 also generates a vertical sync signal AVS in response to the analog vertical sync signal and a horizontal sync signal AHS in response to the analog horizontal sync signal.

The TMDS receiver 313 receives and decodes image data DIN input as a TMDS receiver protocol for a digital video interface (DVI) and restores the image data DIN into digital data for display. The restored digital data can be used as a signal for scaling. A digital signal input through the DVI includes decoded data DD_DATA, digital vertical/horizontal sync signal DVS/DHS, and a clock signal DCKI.

The selection circuit 315 selectively scales a plurality of media and can be implemented by a multiplexer. The selection circuit 315 outputs the analog/digital vertical sync signals AVS/DVS and the analog/digital horizontal sync signals AHS/DHS output from the ADC/PLL 311 or the TMDS receiver 313 as a vertical sync signal VSI and a horizontal sync signal HSI to the timing generator 320 in response to a selection signal (not shown) for selecting a corresponding input media.

The selection circuit 315 also outputs the data AD_DATA/DD_DATA output from the ADC/PLL 311 or the TMDS receiver 313 to the data formatter 317 in response to the selection signal. The selection circuit 315 transmits the clock signal ACKI output from the ADC/PLL 311 or the clock signal DCKI output from the TMDS receiver 313 as an input clock signal CKI to the sampling frequency converter 330 and the timing generator 320 in response to the selection signal.

The data formatter 317 receives the data AD_DATA/DD_DATA output from the selection circuit 315, transforms the format of the received data AD_DATA/DD_DATA, and outputs a transformation result DATA to the sampling frequency converter 330.

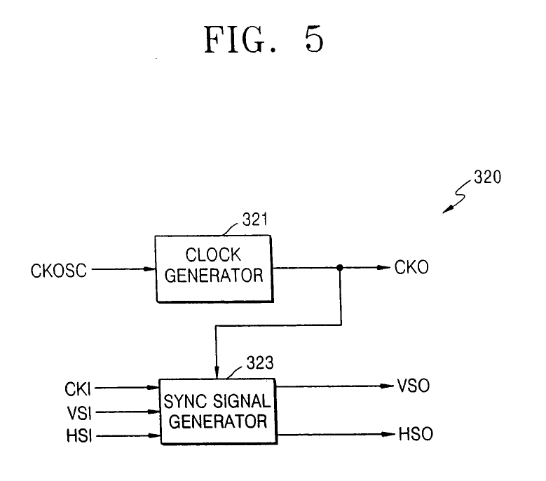

FIG. 5 is a block diagram of the timing generator 320 of FIG. 3. Referring to FIG. 5, the timing generator 320 includes a clock generator 321 and a sync signal generator 323.

The timing generator 320 generates an output clock signal CKO, so that the duration of the vertical active period of an input image frame by the input clock signal CKI and the duration of the vertical active period of an up-scaled output image frame by the output clock signal CKO can be equal. In other words, the timing generator 320 controls the period of the output clock signal CKO.

The clock generator 321 receives a clock signal generated by an independent clock source, such as a crystal clock signal CKOSC output from a crystal oscillator (not shown) and generates the output clock signal CKO in response to the crystal clock signal CKOSC, independently of the input clock signal CKI.

The sync signal generator 323 generates output sync signals that correspond to the up-scaled output image frame, i.e., an output vertical sync signal VSO and an output horizontal sync signal HSO, in response to the input clock signal CKI, the output clock signal CKO, the vertical sync signal VSI, and the horizontal sync signal HSI. It is preferable that the output sync signal be generated at the beginning of the vertical active period of the input image frame.

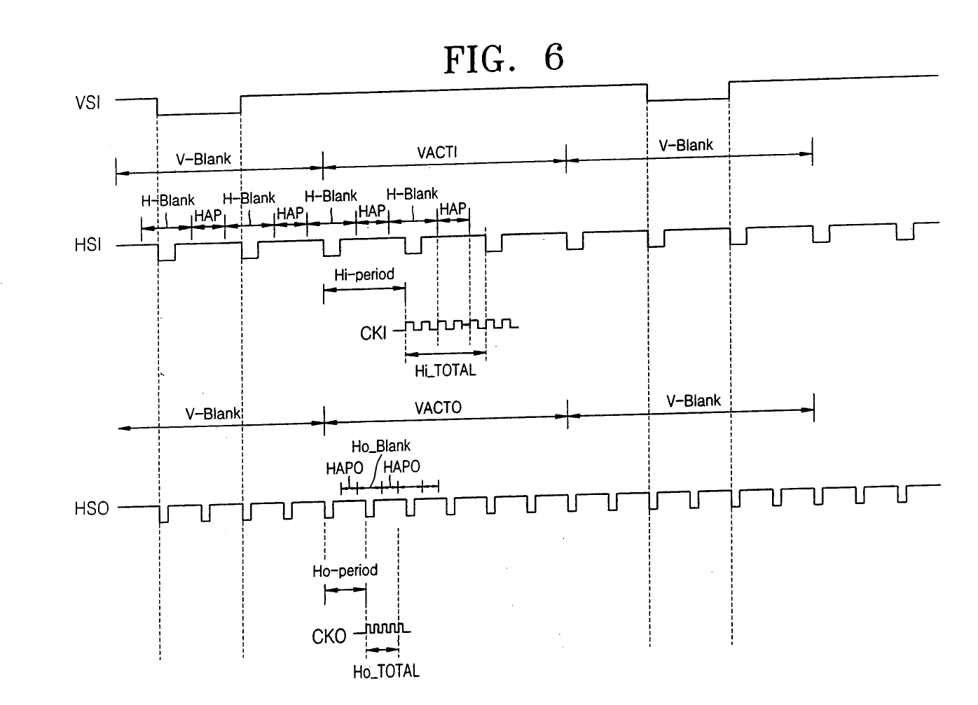

FIG. 6 is a timing diagram for basic operation of the timing generator 320 of FIG. 3. The timing generator 320 outputs the output clock signal CKO during the vertical active period during which real image data is loaded into the input image frame, so that data for the up-scaled output image frame can be output.

Here, H-Blank represents a blank pixel zone of the input horizontal sync signal HSI, Ho_Blank represents a blank pixel zone of the output horizontal sync signal HSO, HAP represents an active pixel zone of the input horizontal sync signal HSI, and HAPO represents an active pixel zone of the output horizontal sync signal HSO.

First, to facilitate description of the present invention, notation is defined as follows.
CKI: input clock signal;
VACTI: the number of input scan lines that forms a vertical active period of an input image frame;
VACTO: the number of scan lines that forms a vertical active period of an up-scaled output image frame;
HI_Period: a period (sec) of the input horizontal sync signal HSI for the input image frame;
HO_Period: a period (sec) of the output horizontal sync signal HSO for the up-scaled output image frame;
HITOTAL (=HAP+H_Blank): the number of pixels that correspond to one period of the input horizontal sync signal HSI for the input image frame;
HOTOTAL (=HAPO+Ho_Blank): the number of pixels that correspond to one period of the output horizontal sync signal HSO for the up-scaled output image frame.

Here, VACTI and HITOTAL are determined according to the input image frame (or a video signal) and VACTO is determined according to the vertical active period H-Active Pixel to be up-scaled. Also, HAPO of the HOTOTAL is determined according to the active pixel zone (H-Active Pixel).

Here, the up-scaled blank pixel zone Ho-Blank is not fixed and may be set quite freely in an up-scaling ratio. Thus, HOTOTAL itself may be set quite freely according to the active pixel zone HAPO to be up-scaled.

The timing generator 320 generates the output clock signal CKO, so that the duration of VACTI and the duration of VACTO are equal. Such an operation can be expressed as follows:
VACTI*HI_{—}Period=VACTO*HO_{—}Period
HI_{—}Period=CKI*HITOTAL
HO_{—}Period=CKO*HOTOTAL (1)

To calculate the output clock signal CKO, Equation 1 can be rewritten as:
VACTI*(CKI*HITOTAL)=VACTO*(CKO*HOTOTAL)
CKO=(VACTI*CKI*HITOTAL)/(VACTO*HOTOTAL) (2)

Thus, if the output clock signal CKO is generated according to Equation 2, the duration of VACTI and the duration of VACTO are equal.

FIG. 7 is a block diagram of the clock generator 321 of FIG. 5.

The clock generator 321 of FIG. 7 generates the output clock signal CKO in accordance with Equation 2. Referring to FIG. 7, the clock generator 321 includes a pre-divider 701, a phase locked loop (PLL) 700, and a decimal fraction adder 713.

The pre-divider 701 receives the crystal clock signal CKOSC and generates a clock signal FIN that results from dividing the crystal clock signal CKOSC by an integer P in response to a first division control signal P. Here, P is an integral number.

The PLL 700 receives the clock signal FIN output from the pre-divider 701 and generates the output clock signal CKO that is phase-locked with the clock signal FIN in response to a second division control signal M.

The decimal fraction adder 713 outputs the second division control signal M in response to a third division control signal M_org, such that the second division control signal M can be represented by an integer.

The PLL 700 includes a phase-frequency detector 703, a charge pump 705, a voltage controlled oscillator (VCO) 707, a main-divider 709, and a post-scaler 711. The main-divider 709 divides an output signal of the VCO 707 by M in response to the second division control signal M output from the decimal fraction adder 713 and outputs a division result MVCO to the phase-frequency detector 703. Here, M is an integer that may vary.

The phase-frequency detector 703 compares phase/frequency of the clock signal FIN with that of the division result MVCO output from the main-divider 709 and outputs a comparison result to the charge pump 705. The charge pump 705 applies a voltage to the VCO 707 in response to an output of the phase-frequency detector 703.

The VCO 707 outputs a signal having a frequency that is controlled by (proportional or inversely proportional to) the voltage applied by the charge pump 705. The post-scaler 713 receives the output signal of the VCO 707, divides the output signal of the VCO 707 by S (or 2^{S}) in response to a fourth division control signal S, and generates the output clock signal CKO as a result of division. It is preferable that S be an integer.

The output clock signal CKO is given by
CKO=(CKOSC*M)/(P*2^{S}) (3),
where if S is 0, Equation 3 can be rewritten as:
   CKO=(CKOSC*M)/(P) (4),
and it is preferable that M be an integer, but may be a real number. Thus, if M is expressed as a decimal number M_org, include decimal number M, Equation 4 can be expressed as:
   CKO=(CKOSC*M_{—}org)/(P) (5),

The third division control signal M_org can be calculated using Equations 2 and 5 as follows:
(CKOSC*M_{—}org)/P=(VACTI*CKI*HITOTAL)/(VACTO*HOTOTAL) M_{—}org=(P*CKI*HITOTAL*VACTI)/(CKOSC*HOTOTAL*VACTO) (6)

The third division control signal M_org is determined based on Equation 6. The third division control signal M_org may or may not be an integer.

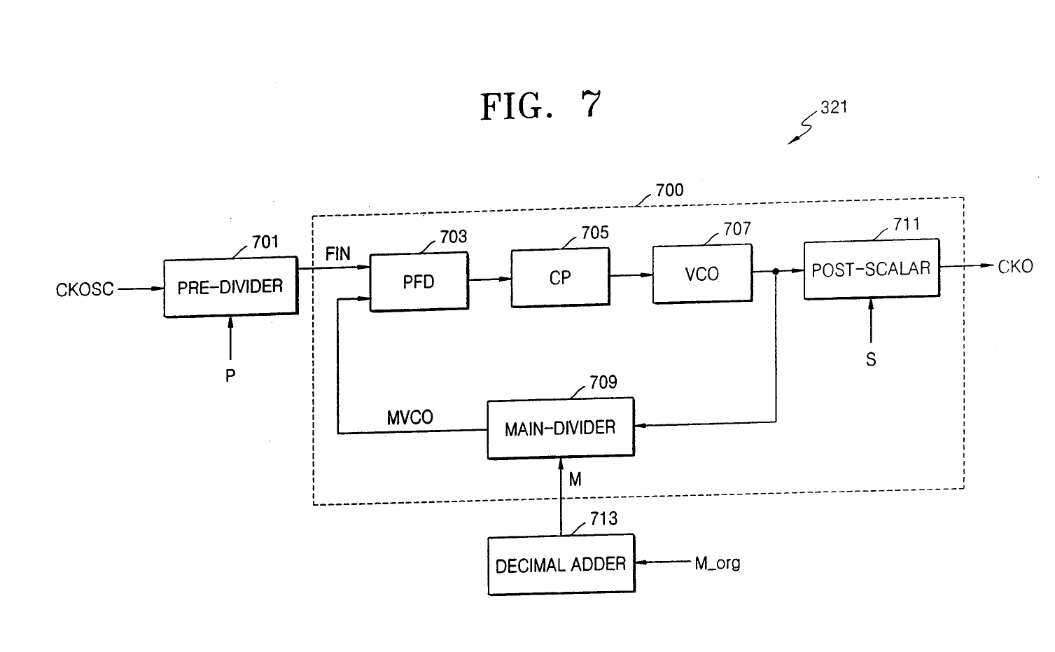

The decimal fraction adder 711 receives the third division control signal M_org input from an external source and outputs the second division control signal M having an integral value to the main-divider 709 using a fraction added method. FIG. 8 is a timing diagram for operation of the decimal fraction adder 713 of FIG. 7.

The decimal fraction adder 713 includes a predetermined storage device (not shown) that stores a real number M_fract that forms a decimal part of the third division control signal M_org and adds and accumulates the real number M_fract to a previous real number stored in the storage device during each period. At this time, if the accumulated value includes an integer that is greater than one, the integral value is added to the second division control signal M during the period.

FIG. 8 illustrates a case where the third division control signal M_org calculated in Equation 6 is 1500.4. The decimal number M_fract (=0.4) is stored in the predetermined storage device and the decimal fraction adder 711 outputs 1500 as the second division control signal M.

Since the decimal number M_fract (=0.4) is added to the decimal number stored in the storage device, 0.4, during the next period, the decimal number is stored in the storage device is 0.8. In this case, the decimal adder 711 outputs 1500 as the second division control signal M.

Since the decimal number M_fract (=0.4) is added to the decimal number stored in the storage device, 0.8, during the next period, the decimal number that is stored in the storage device is 1.2. The decimal adder 711 then outputs 1501 as the second division control signal M during this period. At this time, the decimal number stored in the storage device, 1.2, is changed to 0.2, and the decimal number M_fract (=0.4) is added to the decimal number 0.2 stored in the storage device during the next period. As a result, the decimal number stored in the storage device is 0.6. Also, when the decimal number stored in the storage device is 1.0, the decimal adder 711 outputs 1501 as the second division control signal M during this period.

Referring to FIG. 3, the SFC 330 has a dual port SRAM or a device with two ports at each side and may use a first port for a data write operation and a second port for a data read operation.

A plurality of pixel data DATA forming the input image frame is written to a predetermined memory device included in the dual port SRAM through one of the first and second ports in response to the input clock signal CKI. Pixel data DATA stored in the predetermined memory device is duplicated in the vertical and horizontal directions, respectively, as many times as a vertical scaling factor and/or a horizontal scaling factor. A plurality of duplicated pixel data EDATA are read through one of the first and second ports in response to the output clock signal CKO.

Thus, during the vertical active period of the input image frame in the input clock signal CKI, the duplicated pixel data EDATA is output to the line buffer 340 in response to the output clock signal CKO. In other words, the SFC 330 duplicates the plurality of pixel data DATA in the horizontal and vertical directions as many times as the number of output data to be up-scaled. Then the SFC 330 outputs the duplicated pixel data EDATA to the line buffer 340 in response to the output clock signal CKO.

The SFC control circuit 321 controls timing operations for the data write and data read operations of the SFC 330 in response to the output clock signal CKO, the vertical signal VSO, and the horizontal signal HSO output from the timing generator 320. For example, the SFC control circuit 321 outputs a write address WADD and a write enable signal WEN that are required for the data write operation in the SFC 330 to the SFC 330 and outputs a read address RADD and a read enable signal REN that are required for the data read operation in the SFC 330 to the SFC 330.

The line buffer 340 receives the duplicated pixel data EDATA and outputs the duplicated pixel data EDATA to the vertical interpolator 350 in response to the output clock signal CKO. The line buffer 340 has a data line hold function, thus if a data line provided by scaling is an invalid data line, the line buffer 340 reads data corresponding to the invalid data line, but does not write the data, and corrects the pixel data EDATA output from the SFC 330. In other words, data of a line including invalid data that is wrongly output from the SFC 330 can be corrected using the data of a previous scan line.

For example, if a predetermined image is scaled by 1.25 in the vertical direction and not scaled in the horizontal direction, the SFC 330 should generate data of 5 scan lines for every four scan lines. However, the SFC 330 may output data of 4 valid scan lines and data of one invalid scan line. In this case, since the data of the one invalid scan line is not written to the line buffer 340, the line buffer 340 repeatedly outputs data of a previous scan line only through a data read operation.

The vertical interpolator 350 receives a signal output from the line buffer 340 and performs vertical interpolation on the signal output from the line buffer 340 using coefficients generated by the vertical coefficient generator 351. At this time, the line buffer 340 operates as a delay device.

The horizontal interpolator 360 receives a signal output from the vertical interpolator 350 and performs horizontal interpolation on the signal output from the vertical interpolator 350 using coefficients generated by the horizontal coefficient generator 361. Here, interpolation is performed through classification in the vertical/horizontal directions using classification characteristics of an image.

The output formatter 370 receives a signal output from the horizontal interpolator 360, transforms a format of the received signal, and outputs digital data that is formatted for a predetermined display device. The predetermined display device displays up-scaled pixel data in response to the output clock signal CKO.

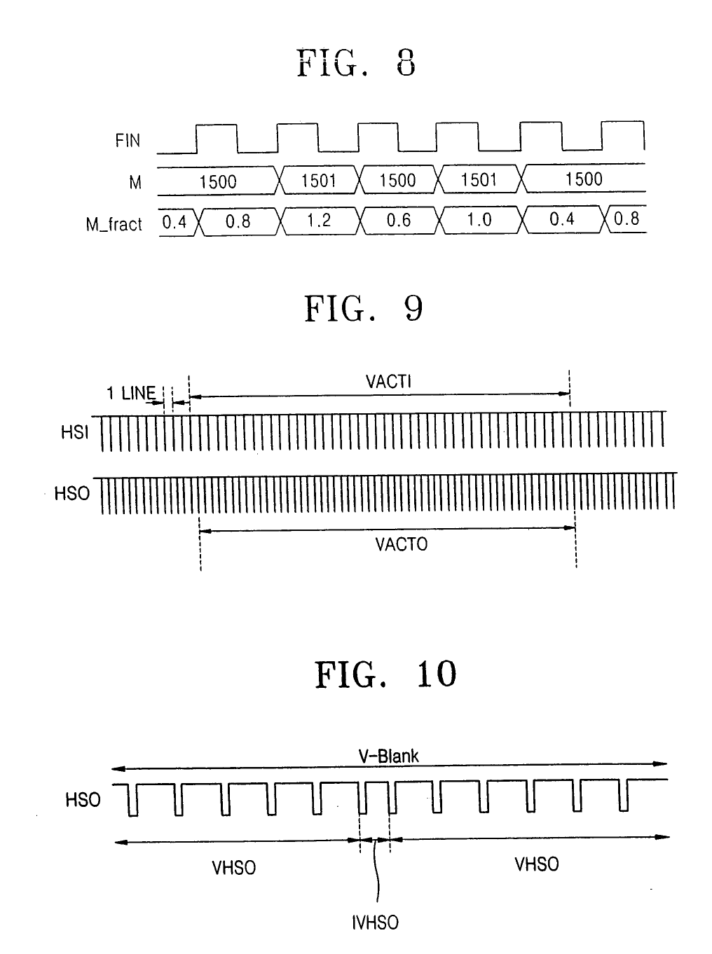

FIG. 9 is a timing diagram of input/output signals of the timing generator 320 of FIG. 5. Referring to FIG. 9, the output clock signal CKO is calculated, so that the duration of VACTI and the duration of VACTO are equal to each other, and pixel data, which is up-scaled during the duration of VACTO, is output. Since the number of scan lines of the vertical blank period V-Blank is repeated at an interval determined in an active zone of the image, it needs not be proportional to the number of input lines. As a result, during the vertical blank period V-Blank, the output horizontal sync signal HSO may not form a complete scan line.

It is also important to find the location of the first pixel of the first line at which VACTI of the input frame begins. Assuming that the location of the first pixel of the first line at which VACTI of the input frame begins corresponds to an n^{th} vertical line and an m^{th} horizontal pixel based on the input clock signal CKI and the vertical sync signal VSI, the output sync signal is generated using timing that is based on the output clock signal CKO in the output image frame for scaling, so that an active signal in which VACTO begins at the location of the n^{th} line and the m^{th} pixel can be generated.

Management of active timing of an output image is intended to secure stable data over the entire display zone by preventing loss of input data for image scaling when a storage space of a buffer (image data corresponding to one line in the present invention) is limited.

Matching the start point of the input vertical active zone and the start point of the output vertical active zone (during implementation, movement for matching group delays or a margin within a limited storage space of a buffer is allowed) is an important factor in the present invention. Through such matching, when a sync signal for an output corresponding to an input is made for scaling, it becomes unnecessary to cause the sync signal for the output to be proportional to the input.

According to this method, if the number of active pixels corresponding to one horizontal line is determined, a user can use a sync period and the number of front porch and back porch, irrespective of an input.

FIG. 10 is a timing diagram of a blank period of an output vertical sync signal generated by the timing generator 320 of FIG. 5. Referring to FIG. 10, the output horizontal sync signal HSO forms complete scan lines during a valid output horizontal sync period VHSO and forms an incomplete scan line during an invalid output horizontal sync period IVHSO. In other words, during the vertical blank period V-Blank, at least one invalid output horizontal sync period may occur.

As described above, in a method and apparatus for up-scaling an image according to exemplary embodiments of the present invention, an output clock signal is generated so that the duration of a vertical active period of an input image frame and the duration of a vertical active period of an output image frame are equal. Thus, the frequency of the output clock signal is controlled.

Also, in a corresponding frame of an input image to be scaled, signals corresponding to vertical and horizontal active zones corresponding to an output image are produced based on the horizontal and vertical locations of the first pixel at which the active zones begin. Also, data corresponding to the active zones is managed.

Once the number of pixels corresponding to one horizontal line is determined in this way, the sync period and the number of front porch and back porch can be set by a user, irrespective of the input signal. Thus, when compared to a conventional scaling method in which an output clock signal is generated in proportion to an input clock signal, the present invention makes it possible to prevent the frequency of the output clock signal from being unnecessarily increased.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

1. An up-scaler, which up-scales an input image frame in vertical and horizontal directions and generates an up-scaled output image frame, the up-scaler comprising:
a timing generator, which generates an output clock signal based on an independently generated clock signal; and
a sampling frequency converter, which receives pixel data that forms the input image frame in response to an input clock signal, duplicates the received plurality of pixel data in the vertical and horizontal directions as many times as a vertical scaling factor and a horizontal scaling factor, respectively, and outputs the duplicated pixel data in response to the output clock signal,
wherein the timing generator generates the output clock signal, so that a duration corresponding to a vertical active period of the input image frame and a duration corresponding to a vertical active period of the output image frame up-scaled by the output clock signal are equal.

2. The up-scaler of claim 1, wherein the timing generator controls a period of the output clock signal, so that the duration corresponding to the vertical active period of the input image frame and the duration corresponding to the vertical active period of the up-scaled output image frame are equal.

3. The up-scaler of claim 1, wherein the timing generator comprises:
a pre-divider, which divides the independently generated clock signal in response to a first division control signal;
a phase-locked loop (PLL), which phase locks the output clock signal to an output signal of the pre-divider and outputs the output clock signal in response to a second division control signal; and
a decimal fraction adder, which controls the second division control signal in response to a third division control signal such that the second division control signal has an integer value.

4. The up-scaler of claim 1, wherein the timing generator further comprises a sync signal generator that receives the input clock signal, the output clock signal, and an input sync signal that corresponds to the input image frame and generates an output sync signal that corresponds to the output image frame.

5. The up-scaler of claim 4, wherein a start point of an active period of the output sync signal is generated at the same time as a start point of the vertical active period of the input image frame.

6. The up-scaler of claim 4, wherein the output sync signal includes an output vertical sync signal and an output horizontal sync signal and a vertical blank period of the output image frame includes at least one incomplete horizontal sync signal.

7. The up-scaler of claim 1, wherein the sampling frequency converter is a dual port SRAM or a dual bank SRAM.

8. The up-scaler of claim 1, wherein the sampling frequency converter comprises a dual port SRAM and the pixel data that forms the input image frame is written to the dual port SRAM through one of two input ports of the SRAM in response to the input clock signal and the plurality of duplicated pixel data is read through one of the two output ports of the SRAM in response to the output clock signal.

9. The up-scaler of claim 1, further comprising a line buffer that stores the plurality of duplicated pixel data output from the sampling frequency converter.

10. The up-scaler of claim 9, further comprising an interpolator that interpolates the pixel data stored in the line buffer and generates the up-scaled output image frame.

11. The up-scaler of claim 1 further comprising a crystal oscillator that generates the independently generated clock signal.

12. An up-scaler, which up-scales an input image frame in vertical and horizontal directions and creates an up-scaled output image frame, the up-scaler comprising:
a timing generator, which generates an output clock signal based on an independently generated clock signal; and
a sampling frequency converter, which receives pixel data that forms the input image frame in response to an input clock signal, duplicates the pixel data in the vertical and horizontal directions as many times as a vertical scaling factor and a horizontal scaling factor, respectively, and outputs the plurality of duplicated pixel data in response to the output clock signal,
wherein the timing generator generates the output clock signal based on the following equation:
CKO=(VACTI*CKI*HITOTAL)/(VACTO*HOTOTAL),
where CKO represents the period of the output clock signal, VACTI represents the number of input scan lines that forms a vertical active period of the input image frame, CKI represents the period of the input clock signal, HITOTAL represents the number of pixels that forms one input scan line, VACTO represents the number of output scan lines that forms the up-scaled output image frame, and HOTOTAL represents the number of pixels that forms one output scan line.

13. A method of up-scaling an input image frame in vertical and horizontal directions and generating an up-scaled output image frame, the method comprising:
generating an output clock signal based on an independent clock signal output from an independent source; and
receiving pixel data that forms the input image frame in response to an input clock signal, duplicating the pixel data in the vertical and horizontal directions as many times as a vertical scaling factor and a horizontal scaling factor, respectively, and outputting the duplicated pixel data in response to the output clock signal.

14. The up-scaling method of claim 13, wherein each of a plurality of scan lines that forms the up-scaled output image frame includes a plurality of active pixels and a plurality of blank pixels, and wherein the number of the plurality of blank pixels that forms each of the scan lines is not necessarily equal for the vertical scaling factor and the horizontal scaling factor.

15. A method of up-scaling an input image frame in vertical and horizontal directions and generating an up-scaled output image frame, the up-scaling method comprising:
receiving pixel data that forms the input image frame in response to an input clock signal;
duplicating the pixel data in the vertical and horizontal directions as many times as a vertical scaling factor and a horizontal scaling factor, respectively; and
outputting the plurality of duplicated pixel data in response to an output clock signal,
wherein a period of the output clock signal is controlled such that a duration corresponding to a vertical active period of the up-scaled output image frame and a duration corresponding to a vertical active period of the input image frame are equal.

16. The up-scaling method of claim 15, wherein a duration corresponding to a blank period of the up-scaled output image frame is different from a duration corresponding to a blank period of the input image frame.

17. The up-scaling method of claim 15, further comprising receiving the plurality of duplicated pixel data and interpolating the plurality of received pixel data, thereby generating the up-scaled output image frame.

18. A method of up-scaling an input image frame in vertical and horizontal directions and generating an up-scaled output image frame, the up-scaling method comprising:
receiving pixel data that forms the input image frame in response to an input clock signal;
duplicating the pixel data in the vertical and horizontal directions as many times as a vertical scaling factor and a horizontal scaling factor;
generating an output clock signal such that all duplicated pixel data can be output during a vertical active period of the input image frame by the input clock signal; and
outputting the plurality of duplicated pixel data in response to the output clock signal.
